(19) United States
(12) Patent Application Publication
(10) Pub. No.: US 2020/0082485 A1
(43) Pub. Date: Mar. 12, 2020

(54) LOYALTY PROGRAM SYSTEM

(71) Applicant: Abilene Christian University, Abilene, TX (US)

(72) Inventor: Scott Hinshaw, Trophy Club, TX (US)

(21) Appl. No.: 16/682,688

(22) Filed: Nov. 13, 2019

Related U.S. Application Data
(60) Provisional application No. 62/767,662, filed on Nov. 15, 2018.
(60) Provisional application No. 62/840,131, filed on Apr. 29, 2019.

(51) Int. Cl. G06Q 50/20; G06Q 30/02; G06Q 20/34

(52) U.S. Cl. CPC G06Q 50/2053; G06Q 30/0215; G06Q 20/3572; G06Q 20/355; G06Q 30/0236

(57) ABSTRACT

A method that includes receiving, from educational institutions, a rule set for each educational institution; receiving, from merchants, user data and usage data for a plurality of users; wherein each user is associated with an educational institution; wherein each educational institution is associated with a branding theme that comprises any one or more of: a name of the educational institution, a name of a mascot of the educational institution, and a color theme associated with the educational institution; calculating, for each user and based on the user data for the user, usage data for the user, and the rule set for the educational institution that is associated with the user, a reward point balance; and displaying, for each user and using the branding theme associated with the educational institution associated with the user, an available reward points balance on a graphical user interface that is associated with the user.

This application claims the benefit of the filing date of, and priority to, U.S. Application No. 62/767,662, filed Nov. 15, 2018, the entire disclosure of which is hereby incorporated herein by reference.

This application also claims the benefit of the filing date of, and priority to, U.S. Application No. 62/840,131, filed Apr. 29, 2019, the entire disclosure of which is hereby incorporated herein by reference.

### BACKGROUND

The increasing costs of higher education have dramatically outpaced inflation and earnings for many years. Meanwhile, the ability to obtain student loans has dropped significantly for many potential students and their families. As such, paying for higher education has become incredibly difficult for many families who aspire to send their children to college.

At the same time, many universities are struggling to remain financially solvent as many students are choosing to forego higher education due to the steep costs. Exacerbating the problem for four-year universities is the fact that students are increasingly buying fewer and fewer of their college credits at the four-year university, opting to pay for core credits through cheaper community college and dual credit high school courses. The result is a cycle where universities must raise their prices to cover their costs spread over fewer students, which leads to lower enrollment, which leads to more tuition rate increases, and on and on.

Meanwhile, the United States has seen a dramatic rise in the number of rewards programs where rewards program members are able to earn benefits with a company or institution they aspire to engage with, often funded by 3^{rd} parties like credit card issuers, travel companies, restaurants, retail stores, and more. Rich customer benefits are attainable through these rewards programs for almost every company in almost every industry in the United States today, with the exception of universities.

### BRIEF DESCRIPTION OF THE DRAWINGS

FIG. 1 is a diagrammatic illustration of a loyalty program system, according to an example embodiment, the system including a card reader, a remote user device, an identification card, and a reward program module.

FIG. 2 is an illustration of the card reader and the identification card of FIG. 1, according to an example embodiment.

FIG. 3 is an illustration of the card reader and the identification card of FIG. 1, according to another example embodiment.

FIG. 4 is an illustration of the reward program module of FIG. 1, according to an example embodiment, the reward program module including reward matching rules, reward calculation rules, reward redemption/exchange rules, reward fulfillment rules, investment rules, and a user rewards redemption module.

FIG. 5 is an illustration of the reward matching rules of FIG. 4, according to an example embodiment.

FIG. 6 is an illustration of the reward calculation rules of FIG. 4, according to an example embodiment.

FIG. 7 is an illustration of the reward redemption/exchange rules of FIG. 4, according to an example embodiment.

FIG. 8 is an illustration of the reward fulfillment rules of FIG. 4, according to an example embodiment.

FIG. 9 is an illustration of the investment rules of FIG. 4, according to an example embodiment.

FIG. 10 is a flow chart illustration of a method of operating the system of FIG. 1, according to an example embodiment.

FIG. 11 is a data and process flow for the system of FIG. 1 during a step of the method of FIG. 10, according to an example embodiment.

FIG. 12 is a data and process flow for the system of FIG. 1 during another step of the method of FIG. 10, according to an example embodiment.

FIG. 13 is an illustration of a graphical user interface of the remote user device of FIG. 1 during a step of the method of FIG. 10, according to an example embodiment.

FIG. 14 is an illustration of graphical user interface of the remote user device of FIG. 1 during another step of the method of FIG. 10, according to an example embodiment.

FIG. 15 is a data and process flow for the system of FIG. 1 during yet another step of the method of FIG. 10, according to an example embodiment.

FIG. 16 is a diagrammatic illustration of the remote user device of FIG. 1, according to an example embodiment.

FIG. 17 is a diagrammatic illustration of a node for implementing one or more example embodiments of the present disclosure, according to an example embodiment.

### DETAILED DESCRIPTION

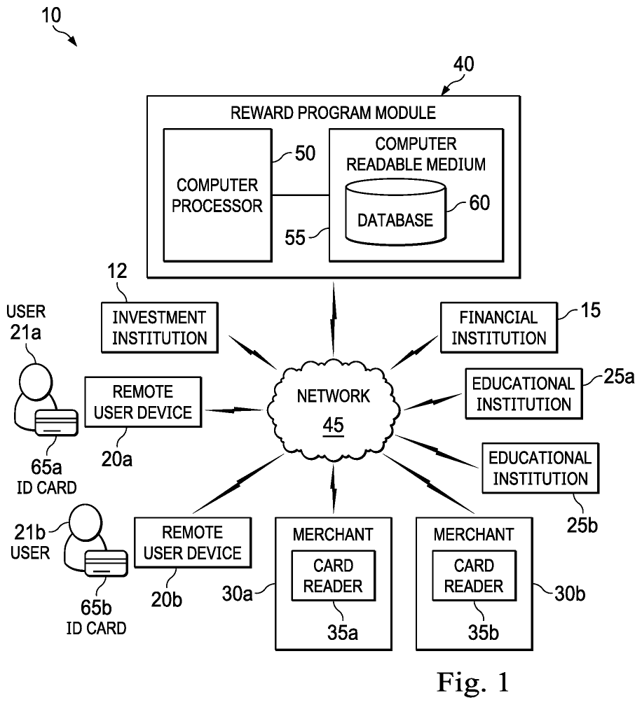

A system generally referred to by the reference numeral 10 as illustrated in FIG. 1 is a loyalty program application. The system 10 facilitates reward points redemption transactions between a rewards program and a participating merchant or provider of a tuition credit/certificate and/or a college savings financial investment (e.g., a 529 savings or prepaid 529 plan). The system 10 includes the computer logic necessary to compute and store the transaction with the capability of appropriately calculating, storing, and/or tracking: the amount of rewards currency required for a given reward; the funds applied to the reward from the rewards program; any potential further funding of the reward from a 3^{rd} party, the university, or a marketing partner; an alternate redemption value to a customer or use of the reward program for potentially an array of uses for a tuition credit/certificate; the corresponding billing and collection of necessary funds to pay for the reward; a display for transaction fulfillment regarding the reward to the customer; and/or the investment of the accompanying funds for the reward in accordance with the terms and conditions of the agreement(s) with the university and/or the customer. Generally, the system 10 is configured to provide rewards programs to a variety of educational institutions via purchases at the educational institutions and/or at merchant partners. Users, such as prospective students of an educational institution, view a customized graphical user interface when interacting with the system 10. As such, the system 10 handles rewards for a variety of educational institutions while providing a customized experience to each user.

In an example embodiment, as illustrated in FIG. 1, the system 10 includes an investment institution 12, a financial institution 15, remote user devices 20a, 20b that are associated with users 21a, 21b respectively, an education institution 25a, an education institution 25b, merchants 30a, 30b that are associated with card readers 35a, 35b respectively, and a reward program module 40 that all are operably coupled together, and in communication via a network 45. Generally, the reward program module 40 includes a computer processor 50 and a computer readable medium 55 operably coupled thereto. Instructions accessible to, and executable by, the computer processor 50 are stored on the computer readable medium 55. A database 60 is also stored in the computer readable medium 55. Each of the remote user devices 20a, 20b includes a graphical user interface (“GUI”) that is capable of displaying a plurality of windows or screens to the user 21a, 21b, respectively. In some embodiments, the system 10 also includes identification (“ID”) cards 65a, 65b that are associated with the users 21a, 21b, respectively.

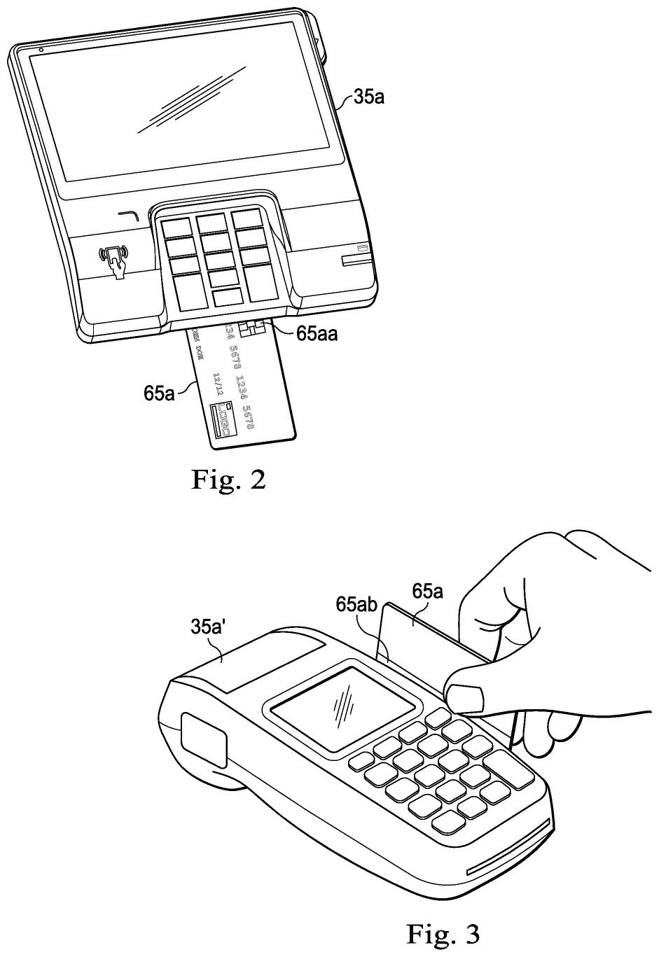

In an example embodiment and referring to FIG. 2, the ID card 65a includes a user identifier or other identifier that is associated with the user 21a. In some embodiments, the ID card 65a is a wallet-sized plastic card, a keychain fob, etc. In an example embodiment and as illustrated in FIG. 2, the ID card 65a includes a chip 65aa that stores data that identifies the user 21a, such as the credit card account associated with the user 21a, and/or the rewards account associated with the user 21a. As illustrated in FIG. 2, a portion of the ID card 65a, which includes the chip 65aa, is sized to be inserted into the reader 35a such that the reader 35a is provided the account number and/or the identifier of the user 21a. In some embodiments, a plurality of numbers is displayed on the card 65a and the plurality of numbers is associated with an account of the user 21a. That is, a credit card number is displayed on the card 65a and the credit card number is associated with a credit card account. The credit card account can be the same as or can be associated with a rewards account.

In other embodiments and as illustrated in FIG. 3, instead of, or in addition to, the chip 65aa, the ID card 65a includes a magnetic stripe 65ab that stores data that identifies the user 21a, such as the credit card account associated with the user 21a, and/or the rewards account associated with the user 21a. When the card 65a includes the magnetic stripe 65ab, generally a portion of the card 65a that includes the magnetic stripe 65ab is inserted into or swiped across a magnetic stripe reader that forms a portion of a card reader 35a′. Regardless, the credit card account of the user 21a and/or the rewards account of the user 21a is identified when using the ID card 65a with the card reader 35a or 35′. In some embodiments, the ID card 65a is a credit card or other method of payment.

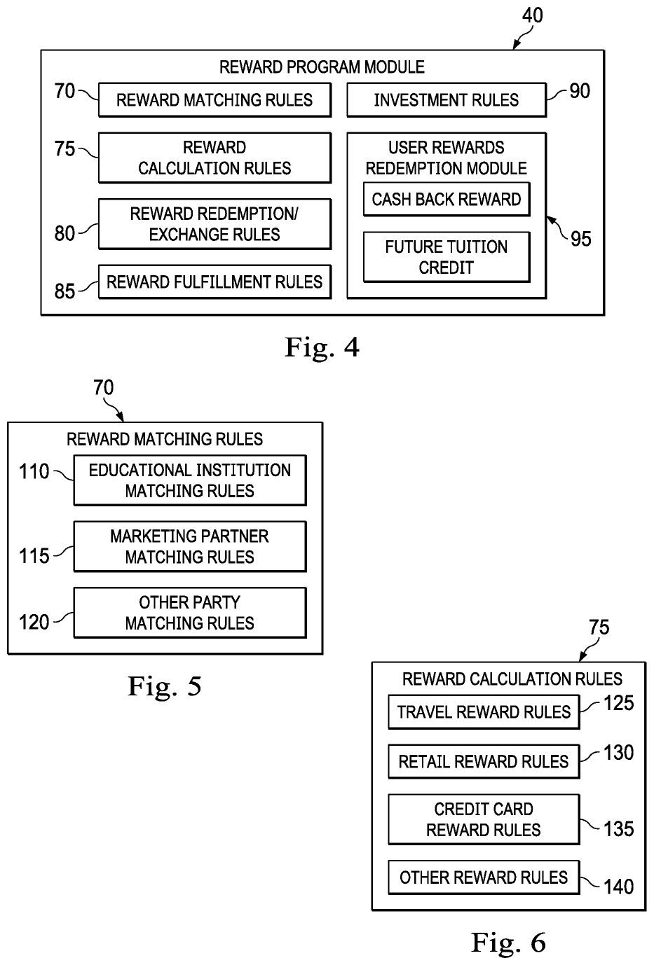

In an example embodiment, the reward program module 40 includes a plurality of rules and modules. For example, and as illustrated in FIG. 4, the reward program module 40 includes reward matching rules 70, reward calculation rules 75, reward redemption/exchange rules 80, reward fulfillment rules 85, investment rules 90, and a user rewards redemption module 95. In some embodiments, the redemption module 95 includes a “Cash Back Reward” option and a “Future Tuition Credit” option. In some embodiments, the reward program module 40 is located or hosted across a variety of platforms and servers, with different portions of the module 40 being controlled and/or supervised by a plurality of owners and entities or at least differently branded entities. Generally, each education institution is associated with a different branding theme. In some embodiments, the redemption module 95 associates a branding theme with each educational institution. For example, the educational institution 25a may be associated with a tiger mascot, the colors orange, black, and white, a first mascot name, and/or a type of font while the educational institution 25b may be associated with a bear mascot, the colors brown, purple, and gold, a second mascot name, and/or a type of font that is different from the font associated with the educational institution 25a. The redemption module 95 stores the branding theme for each educational institution and is configured to customize a graphical user interface of the remote user devices 20a, 20b depending on the educational institution associated with the users 21a, 21b, respectively. In some embodiments, the redemption module 95 associates one of the educational institutions 25a or 25b with each user. Generally, the user is associated with the educational institution when the user is a prospective student of the educational institution, the user is a current student of the educational institution, the user is a former student of the educational institution, and/or the user has a family member that is a prospective or current student of the educational institution.

In an example embodiment, and as illustrated in FIG. 5, the reward matching rules 70 include educational institution matching rules 110, marketing partner matching rules 115, and other party matching rules 120.

In an example embodiment, and as illustrated in FIG. 6, the reward calculation rules 75 include travel reward rules 125, retail reward rules 130, credit card reward rules 135, and other reward rules 140.

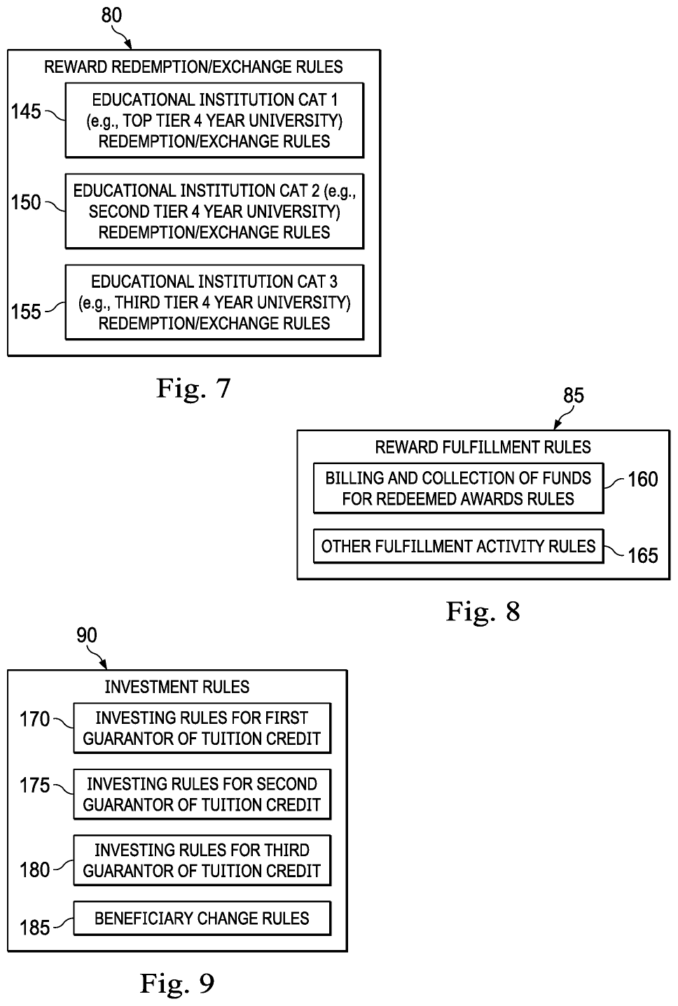

In an example embodiment, and as illustrated in FIG. 7, the reward redemption/exchange rules 80 include educational institution category 1 redemption/exchange rules 145, educational institution category 2 redemption/exchange rules 150, and educational institution category 3 redemption/exchange rules 155.

In an example embodiment, and as illustrated in FIG. 8, the reward fulfillment rules 85 include billing and collection of funds for redeemed awards rules 160, and other fulfillment activity rules 165.

In an example embodiment, and as illustrated in FIG. 9, the investment rules 90 include investing rules for 1^{st} guarantor of tuition credit 170, investing rules for 2^{nd} guarantor of tuition credit 175, investing rules for 3^{rd} guarantor of tuition credit 180, and beneficiary change rules 185.

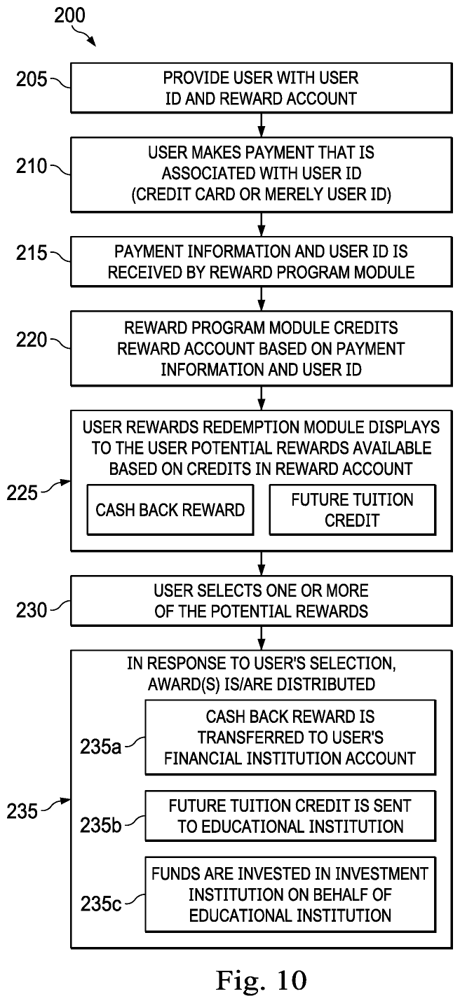

In an example embodiment, as illustrated in FIG. 10 with continuing reference to FIGS. 1-9, a method 200 of operating the system 10 includes providing the user 21a with a user ID and the reward account at step 205; the user 21a making a payment that is associated with the user ID at step 210; receiving the payment information and user ID by the reward program module 40 at step 215; crediting the reward account of the user 21a based on payment information and user ID at step 220; displaying, by the user rewards redemption module, potential rewards available based on a credit balance in the reward account to the user 21a at step 225; the user 21a selecting one or more of the potential rewards at step 230; and in response to the user's selection, distributing the award(s) at step 235.

At the step 205, the user 21a is provided with a User ID and a reward account number that is associated with a reward account. Generally, the user ID is associated with the reward account for the user 21a. In some embodiments, the user ID and the reward account number are stored in the database 60. In some embodiments, each of users 21a and 21b selects to be associated with one of the educational institutions 25a and 25b. As each of the educational institutions 25a and 25b is associated with a branding theme, each of the users 21a and 21b is also associated with a branding theme during the step 205 in some embodiments.

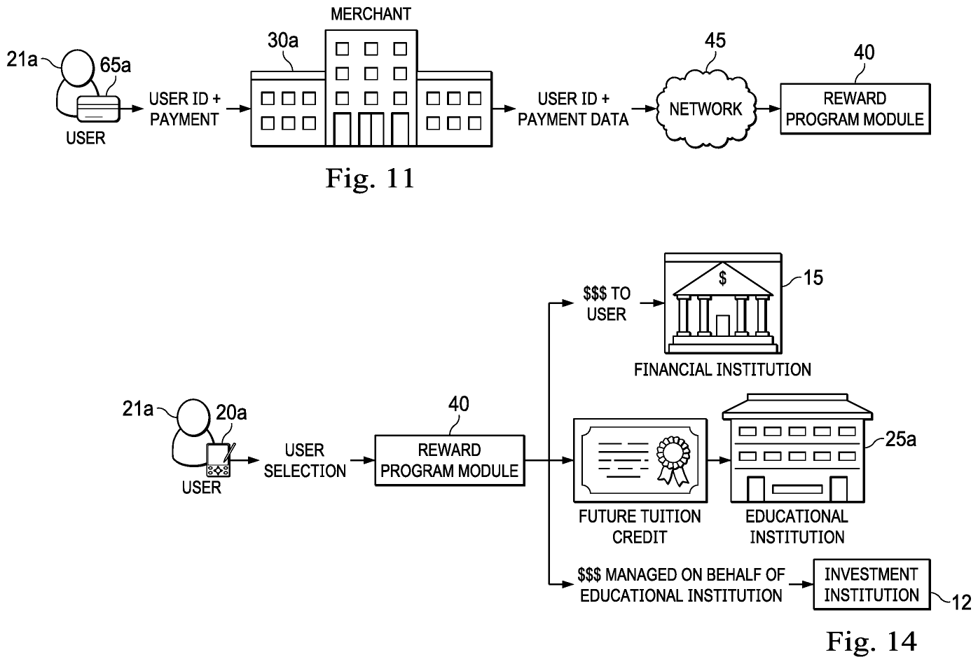

At the step 210, the user 21a makes a payment using the user ID or using a credit card that is associated with the user ID. As illustrated in FIG. 11, the user 21a uses his or her ID card 65a to make a payment with the merchant 30a. In some embodiments, the user 21a physically provides the card 65a to the merchant for the merchant 30a to use with the card reader 35a. However, in other embodiments, the user 21a merely provides the merchant 30a with the user's credit card number without physically entering a store.

At the step 215, the payment information and user ID is received by the reward program module 40. In some embodiments, the user ID and payment information is sent to the reward program module 40 by the merchant 30a via the network 45. In some embodiments, the user account and user usage data (e.g., payment information, payment total) is identified when the card reader 35a reads the identification card 65a. The card reader 35a is not required to be a physical card reader, but can also include any payment processing means, physical or online.

At the step 220, the reward program account associated with the user ID is credited based on the payment information and user ID. In some embodiments, the system 10 converts the user usage data to reward points and assigns those reward points to the user's account. In some embodiments, the reward program account maintains a balance of credits or total reward points based on the purchase history of the user 21a. Generally, when the user 21a purchases an item or completes an activity, the balance of the reward program account is increased based on the reward matching rules 70. For example, the reward account is credited based on what is purchased or the type of merchant. That is, the system 10 uses the educational institution matching rules 110 when the user 21a purchases items or enters into a transaction with the educational institution 25a. For example, if the user 21a purchases a book from the educational institution 25a, the system 10 credits the reward account by a value that is five times the purchase price of the book. Similarly, the system 10 uses the marketing partner matching rules 115 when the user 21a purchases items or enters into a transaction with a merchant that is a marketing partner. For example, if the user 21a purchases a meal from a restaurant or entity that is a marketing partner, the system 10 credits the reward account by a value that is three times the purchase price of the meal. Marketing partners can be service providers, such as banks, internet service, etc. Other party matching rules 120 are used for the calculation of credits when the merchant 30 is not the educational institution 25a or a marketing partner.

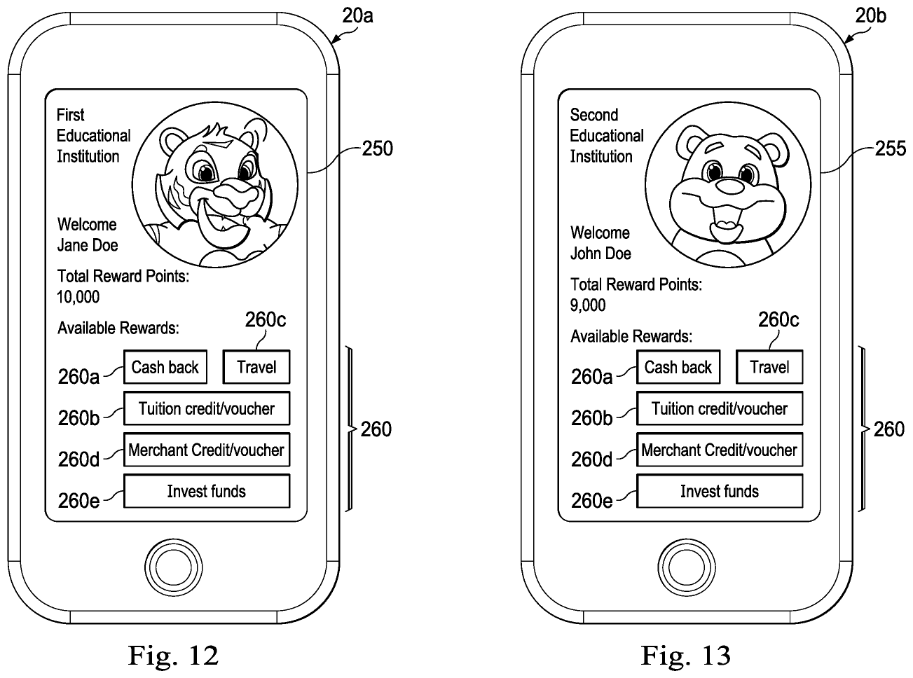

At the step 225 and as illustrated in FIG. 12, the user reward redemption module 40 displays potential rewards to the user 21a. In some embodiments, the system 10 identifies the remote user device 20a that is associated with user 21a and the user account to display the potential rewards to the user 21a. The system 10 uses the branding theme that is associated with the educational institution that is associated with the user 21a. As illustrated in FIG. 12, a graphical user interface 250 is displayed on the remote user device 20a that is associated with the user 21a. In this example, the user 21a has previously selected the educational institution 25a. As such, the branding theme for the educational institution 25a is displayed on the GUI 250 of the remote user device 20a. FIG. 13 illustrates an example of another graphical user interface 255 that is associated with the user 21b that has selected the educational institution 25b, which is different from the educational institution 25a. As such, the branding theme for the educational institution 25b, and compared to the educational institution 25a, includes a different image of a mascot, a different name of the educational institution, etc. In some embodiments, the potential rewards, or available rewards 260 include a cash back award and a future tuition credit. In some embodiments, the potential rewards 260 include a tuition credit/voucher that may be a future tuition credit or a current tuition credit. However, in some embodiments the tuition credit/voucher is a scholarship. In some embodiments, the scholarship is awarded by any one or more of the educational institution 25a, the investment institution 12, and the financial institution 15. In some embodiments, the scholarship is awarded to the user 21a when the user 21a is a current or prospective student. However, in some embodiments the scholarship is awarded to a recipient designated by the user 21a, such as for example when the user 21a is a parent, guardian, or non-relative of a current or prospective student. Generally, the future tuition credit is designed for use in the future (e.g., in months or years) and the current tuition credit can be applied to an outstanding balance at the educational institution 25a. In some embodiments, the user reward redemption module 95 displays additional potential rewards that are not associated with the educational institution, such as for example travel rewards (e.g., buying a travel ticket or hotel stay with the accumulated credits or receiving a reimbursement from the rewards module for the cost of the travel ticket or hotel stay) and/or a merchant reward that is associated with one of the merchants 30a, 30b. In some embodiments, the user reward redemption module 95 is branded or depicted as being associated with the credit card of the user 21a when the ID card 65a is a credit card. That is, the reward redemption module displays a variety of potential rewards to the user, with one of the rewards including a credit relating to an educational institution.

In some embodiments, the system 10 uses the reward calculation rules 75 to determine the number of credits needed to redeem an award. For example, the minimum number of credits needed to redeem a travel reward is based on the travel reward rules 125. In some instances, the travel reward rules 125 use the type of travel, the time of day, the seasonality, the class of travel, the ticket price of the travel reward, etc. to determine the minimum number of credits needed to redeem a travel reward. Moreover, a minimum number of credits needed to redeem a retail or merchant reward is based on the retail reward rules 130. In some instances, the retail reward rules 130 use a value of the retail item, the suggested retail price of the retail item, etc. to determine the minimum number of credits or threshold level of points needed to redeem a retail reward. In some instances, the credit card reward rules 135 consider the account status of the user 21a, payment history of the user 21a, etc. to determine the number of credits to redeem a reward. Other reward rules 140 are used for the calculation of the number of credits when the reward is not determined by the travel reward rules 125, the retail reward rules 130, and the credit card reward rules 135. For example, the other reward rules 140 are used to determine the minimum number of credits needed to redeem or request one future tuition credit, one current tuition credit, a percentage of future annual tuition, or the cash back option. In some embodiments, the reward redemption/exchange rules 80 are also considered to determine the number of credits needed to redeem an award at a specific educational institution.

At the step 230, the user 21a selects one or more of the potential rewards. In some embodiments, the user selecting one or more of the potential rewards includes selecting a selectable icon 260a, 260b, 260c, and 260d that is displayed on the GUI 250 of the remote user device 20a, checking a selectable box displayed on the GUI 250, moving a toggle button that is displayed on the GUI 250, etc. However, the selection can include giving an oral or written command to select the one or more potential rewards. In some embodiments, selection of the tuition credit icon 260b or cash back option icon 206a, opens a new screen that requests additional information from the user and/or requests authorization for the system 10 to open an account, transfer funds, etc. In some embodiments, the new screen also includes the branding theme of the educational institution 25a. In some embodiments, the system 10 uses information or data associated with the credit card account or rewards account of the user 21a to prepopulate an application to open a new account and/or to open a new account. The new account may be with the educational institution 25a associated with the selected tuition credit, with the financial institution 15, and/or with the investment institution 12. In some embodiments, the new account may be opened without the user 21a having to separately and independently create, outside of his or her actions with the rewards module 40, the new account with the financial institution 15, the educational institution 25a, and/or the investment institution 12. In some embodiments, the new account is a tentative, pending, or provisional account that requires the user 21a to complete an action, such as provide signature or identification, before the tentative, pending, or provisional account is classified as new account but does not require completion of all of the traditional actions associated with opening a new account. As such and in some embodiments, the funds to be invested on behalf of the user 21a are deposited into a new account associated with the user 21a without the user 21a having to separately and independently create a new account with that financial institution 15, the investment institution 12, or educational institution 25a. In some embodiments and when an account has already been established for the user 21a at the educational institution 25a, the financial institution 15, and/or the investment institution 12, the selection of the tuition credit or funds merely adds to the account balance for the appropriate account. In other embodiments, the new screen is associated or branded with branding associated with the educational institution 25a, the financial institution 15, the investment institution 12, and/or a credit card company. In some embodiments, the financial institution 15 or the investment institution 12 at which the user account is created funds or credits a portion of the account.

At the step 235, the award is distributed in response to the user's selection. In some embodiments, and as illustrated in FIG. 14, the distribution of the award includes distributing funds to the user 21a via the new account of the user 21a established at the financial institution 15, alerting the educational institution 25a that the user 21a has selected a future tuition credit as the reward, and/or distributing funds to the investment institution 12 in an account that is managed on behalf of the educational institution 25a and/or managed by the user 21a. In some embodiments, the system 10 uses the reward fulfillment rules 85 when distributing the award. That is, the system 10 uses the billing and collection of funds for redeemed awards rules 160 when managing the transfer of the funds or reward from the reward account to the educational institution 25a, the financial institution 15, or the investment institution 12. The system 10 uses the other fulfillment activity rules 165 for other activities that fall outside of the billing and collection of funds. In some embodiments, the step 235 includes creating a voucher for the award selected. The voucher can be sent, transmitted, or otherwise pushed to the merchant partner associated with the voucher or can be sent, transmitted, or otherwise pushed to the user. In some embodiments, the voucher is a tuition credit at the educational institution associated with the user. In some embodiments, sending the voucher includes automatically printing and mailing a physical voucher to the mailing address associated with the user 21a. As such, the use of the system 10 results in a transformation (e.g., creation) of a voucher and/or control of a printer that is printing the voucher and/or mailer to contain the voucher.

The method 200 can be repeated for any number of users, with each user viewing a customized GUI that includes the branding theme of the educational institution that is associated with the user, as illustrated in FIG. 13.

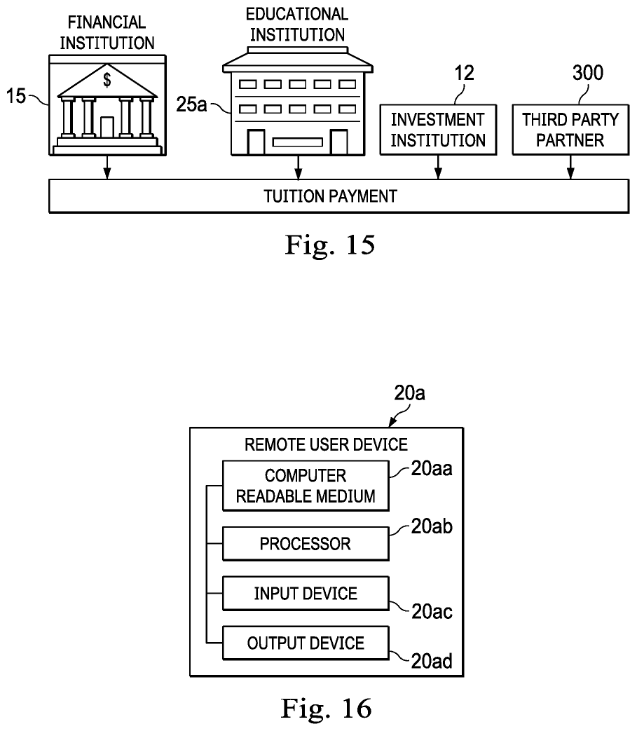

In some embodiments, the method 200 also includes crediting a user's account at the educational institution 25a in response to a request from the user 21a to do so. That is, while some of the rewards distributed at the step 235 are for future payment to the educational institution 25, the method 200 also includes making the payment in or near real-time to the educational institution 25a. The reward amount (i.e., the future tuition creditor cash back) can be formed by the contribution of funds or credits from different entities. For example, and as illustrated in FIG. 15, a portion of a tuition payment credited to the user 21a is received from the financial institution 15, from the educational institution 25a, from the investment institution 12, and from a 3^{rd} party partner 300. In some embodiments, the 3^{rd} party partner 300 includes the merchants 30a, 30b or other 3^{rd} party partners. In some embodiments, the system 10 uses the investment rules 90 when distributing a reward and/or crediting a user's account. For example, the system 10 refers to the investing rules for a 1^{st} guarantor of a tuition credit 170, the investing rules for a 2^{nd} guarantor of a tuition credit 175, the investing rules for a 3^{rd} guarantor of the tuition credit 180, and beneficiary change rules 185 to manage and transfer funds. That is, a first educational institution may have specific rules for investing funds that are designated for the payment of the tuition credit while a second educational institution may have different rules. The system 10 takes these different rules into account and implements rules specific to each educational institution. Moreover, the system 10 manages beneficiary changes via the beneficiary change rules 185. In some embodiments, the system 10 remits appropriate funds with corresponding investment performance to the educational institution, along with the amount of tuition that the educational institution must credit toward the beneficiary.

In some embodiments, the creation of the new account via reward module 40 ensures accuracy of personal details of the user 21a when opening the new account. That is, the personal information used to open or on file for rewards account and/or credit card account is used to open an account at the financial institution 15. Thus, the steps of entering personal information via the GUI of the remote user device 20a or otherwise is omitted, which also reduces the amount of memory required by the remote user device 20a and the system 10. For example, a home address, a full name, contact information, etc. associated with the reward account can be used by the financial institution 15 to create a new account for the user 21a. Moreover, by avoiding the steps of presenting screen(s) to the user 21a to request personal information from the user 21a, the performance of the remote user device 20a is improved. Loading screen(s) on the remote user device 20a increases the processing load on a processor of the remote user device 20a and temporarily requires additional memory. Thus, the prepopulation shortcut provided by the system 10 of creating or crediting an account at a financial institution 15 for the user 21a based on a credit card account or rewards account of the user 21a improves the functioning of the remote user device 20a and requires less memory from the system 10 overall. Moreover, the system 10 results in a method of opening accounts and accumulating tuition credits that is faster and more accurate than conventional methods. Moreover, the accessibility of tuition credits for the user 21a is improved.

In several example embodiments, execution of one or more steps of the method 200 enables the remote user device 20a to forgo creating and/or designing the customized GUI 250. Instead, in several example embodiments, the reward program module 40 continuously and automatically updates the user's reward points balance and creates the layout of the GUI 250 to be displayed on the remote user device 20a. As such, the reward program module 40 improves the functioning of the remote user device 20a. That is, the receipt and upload of a designed GUI 250 by the remote user device 20a eliminates the requirement for the remote user device 20a to calculate the total reward points associated with the user 21a and/or design the GUI 250, which reduces the processing load compared to the remote user device 20a needing to calculate the total reward points associated with the user 21a and/or design the GUI 250. Reducing the processing load of the remote user device 20a generally improves the performance of the remote user device 20a such that the available memory of the remote user device 20a is increased, the processing capacity of the remote user device 20a is increased, therefore making the remote user device 20a operate more efficiently, and the processing speed of the remote user device 20a is increased. Thus, the reward program module 40 improves the functioning of the remote user device 20a itself. That is, the system 10 results in specific improvements in computer capabilities (i.e., reduction of required memory and reduction of processing load).

In some embodiments, the system 10 is a loyalty program with one of the redeemable rewards being a future tuition credit or funds deposited at a financial institution on behalf of the user 21a.

In some embodiments, one of the potential rewards is a combination of a college savings financial instrument and a tuition credit/certificate.

In some embodiments, the system 10 bills and collects the necessary funding for the tuition credit/certificate with potentially the university guarantor funding a portion as a guarantee or through discounts. Moreover, and as detailed above, the system 10 invests the funds at the direction of the guarantor.

In some embodiments, the system 10 calculates and displays in the user's account the value of the tuition credit/certificate, which may be a dollar value, a percentage of annual tuition at a specified university, and may have corresponding alternate values if redeemed at alternate universities. In some embodiments, a separate cash out value of the tuition credit/certificate is available. In some embodiments, a portion of the funds may be used for the system 10 to create and fund a separate college savings financial account that is owned and controlled by the user 21a.

In some embodiments, the system 10 and/or the method 200 allows for the exchange of a rewards program currency for a tuition credit or certificate that facilitates the potential multitude of funding sources, offers potentially multiple alternate tuition credit/certificate values depending on the university that accepts the certificate, invests the funds at the direction of the guarantor of the tuition credit/certificate, administers potential changes in the beneficiary(s), and administers ultimate redemption of the tuition credit/certificate with universities that agree to honor the tuition credit/certificate at the appropriate time, potentially years later.

In some embodiments, the system 10 and/or the method 200 involves a rewards program for multiple colleges or universities and is designed to drive engagement with the university audiences that results in greater revenue for the participating universities. Revenue includes tuition revenue from new students, tuition revenue from retained students, donations, ticket sales, and ancillary revenue from rewards program partners such as credit card or other third-party partners. As such, the system 10 includes the computer logic necessary to calculate, store, and exchange rewards currencies across multiple participating universities. Accordingly, the system 10 is a practical application for loyalty program system designed specifically for educational institutions.

In some embodiments, the system 10 creates a single rewards program that can be used by multiple universities. While one embodiment might allow for the program to be branded uniquely for each participating university, the program is a single program from the perspective of the technology and the potential third party partnerships. That is, the system 10 including the branding theme in the user redemption module 95 results in the generic rewards program being customized to each user. In some embodiments, the rewards program is a single program with configurable customization elements for each university and includes a single rewards currency that can be individually branded. Each university has a suite of potential rewards to opt into, including tuition rewards. That is, there is a plurality of available rewards that are capable of being offered using one of the branding themes and each of the educational instructions selects which available rewards that it wants offered via the rewards program 40. The system 10 also includes one contract between the merchant partners and the rewards program, yet remains customizable or branded for different universities. For example, the merchants 30a, 30b interface with the rewards program module 40 and are not required to enter into contracts with each educational institution. As such, each of the merchants 30a, 30b authorize the reward program module 40 to offer vouchers redeemable at or with the merchants 30a, 30b, respectively. In some embodiments, at least a portion of the rewards available to the users includes university branded goods, university sold goods, and/or priority/preferred access to university related events (i.e., tickets to sporting events, etc.). In some embodiments, the system 10 is a plug and play solution with a variety of merchant partners participating and a variety of educational institutions participating while maintaining a customized interface for each user.

In some embodiments, the investment institution 12 includes any one or more of a bank, an insurance company, a pension, a hedge fund, an investment advisor, an endowment, and a mutual fund.

In some embodiments, the educational institution 25a includes any one or more of a university, a college, a preschool, a primary school, a secondary school, any type of private school, any type of for-profit school or university, etc.

In some embodiments, the financial institution 15 includes any one or more of a bank, a credit union, savings and loans associations, investment companies, etc.

In some embodiments, the merchant 30 includes any one or more of a retail store, food merchant, travel merchant, service provider, or any other type of merchant or provider.

In some embodiments, the rewards available via the system 10 are geared toward future students; current students; and/or alumni/fans. That is, the available rewards 260 displayed on the GUI 250 are dependent upon a status or classification of the user 21a, which may be provided by the user 21a upon opening the rewards account, may be based on the purchase history of the user 21, or may be based on other information associated with the user 21a. In some embodiments, a status or classification includes a future student, a current student, alumni, and a fan. In some embodiments, the rewards geared towards or displayed on the GUI 260 to the future students are meant to create a connection meant to drive incremental new student enrollment, thus increasing tuition revenue. In some embodiments, the rewards geared towards or displayed on the GUI 260 to current students incentivize and reward behaviors that increase retention and therefore increase tuition revenue. In some embodiments, the rewards geared towards or displayed on the GUI 260 to alumni and fans incentivize and reward behavior that leads to greater donations, increased ticket sales, and increased enrollment of alumni children.

In some embodiments, the system 10 measures key performance objectives and is successful in driving incremental tuition, donation, and ticket revenue.

In some embodiments, the system 10 allows for the creation and access of a rewards account with minimal friction. In some embodiments, the system 10 provides the ability to earn rewards with a monetary value and rewards redeemable for special events or access. In some embodiments, the system 10 can incentivize and reward social media behavior, with examples including sharing, friending, following, and/or reacting to university social media posts or to university rewards social media posts. In some embodiments, the system 10 results in a gamified environment where participants can view a leaderboard and participate in activities designed to drive engagement. In some embodiments, the system 10 results in the ability to incentivize and reward attendance or participation in specific activities like visiting campus, attending events and other location/time specific actions. In some embodiments, the system 10 can earn and redeem third party funded rewards from credit card companies and other partners. In some embodiments, the system 10 acts as a bank for all rewards. In some embodiments, the system 10 can facilitate marketing communications in various forms, such as email, social media, messaging, push notification, etc.

In an example embodiment, as illustrated in FIG. 16 with continuing reference to FIG. 1, the remote user device 20a is a computer that includes a computer readable medium 20aa, a processor 20ab, an input device 20ac, and an output device 20ad. In an example embodiment, instructions accessible to, and executable by, the processor 20ab are stored in the computer readable medium 20aa. In an example embodiment, the input device 20ac is a keyboard, mouse, microphone, or other device coupled to the remote user device 20a that sends instructions to the remote user device 20a. In an example embodiment, the input device 20ac and the output device 20ad include a graphical display, which, in several example embodiments, is in the form of, or includes, one or more digital displays, one or more liquid crystal displays, one or more cathode ray tube monitors, and/or any combination thereof. In an example embodiment, the output device 20ad includes a graphical display, a printer, a plotter, and/or any combination thereof. In an example embodiment, the input device 20ac is the output device 20ad, and the output device 20ad is the input device 20ac. In several example embodiments, the remote user device 20a is, or includes, a telephone, a personal computer, a personal digital assistant, a cellular telephone, other types of telecommunications devices, other types of computing devices, and/or any combination thereof. In several example embodiments, the remote user device 20a includes a plurality of remote user devices. In an example embodiment, web browser software is stored in the computer readable medium 20aa.

In one or more example embodiments, the reward program module 40 is stored in the computer readable medium 55 that forms a portion of a computer. In some embodiments, the application includes and/or executes one or more web-based programs, Intranet-based programs, and/or any combination thereof. In an example embodiment, the application includes a computer program including a plurality of instructions, data, and/or any combination thereof. In an example embodiment, the application is written in, for example, Hypertext Markup Language (HTML), Cascading Style Sheets (CSS), JavaScript, Extensible Markup Language (XML), asynchronous JavaScript and XML (Ajax), and/or any combination thereof. In an example embodiment, the application is a web-based application written in, for example, Java or Adobe Flex, which pulls real-time information from another computer and/or a plurality of data sources. In an example embodiment, the application is stored on the computer readable medium 55 and/or in the database 60. In an example embodiment, the computer may include a specially designed code, such as for example SAS code and/or UNIX. In an example embodiment, the SAS code allows communication with an external database, such as a database associated with one or more data sources.

In an example embodiment, the network 45 includes the Internet, one or more local area networks, one or more wide area networks, one or more cellular networks, one or more wireless networks, one or more voice networks, one or more data networks, one or more communication systems, and/or any combination thereof.

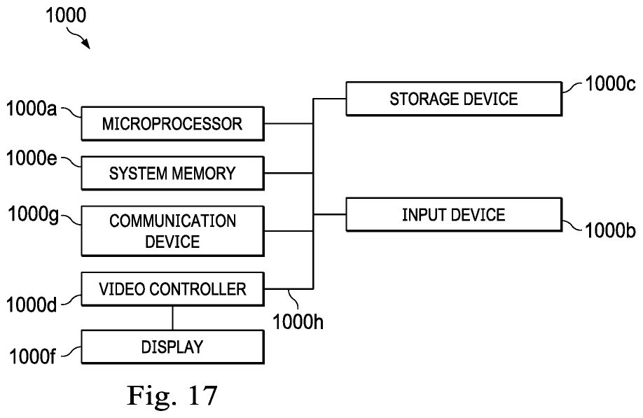

In an example embodiment, as illustrated in FIG. 17 with continuing reference to FIGS. 1-16, an illustrative node 1000 for implementing one or more of the example embodiments described above, illustrated in FIGS. 1-16, is depicted. The node 1000 includes a microprocessor 1000a, an input device 1000b, a storage device 1000c, a video controller 1000d, a system memory 1000e, a display 1000f, and a communication device 1000g, all interconnected by one or more buses 1000h. In several example embodiments, the storage device 1000c may include a floppy drive, hard drive, CD-ROM, optical drive, any other form of storage device and/or any combination thereof. In several example embodiments, the storage device 1000c may include, and/or can receive, a floppy disk, CD-ROM, DVD-ROM, or any other form of computer-readable medium that may contain executable instructions. In several example embodiments, the communication device 1000g may include a modem, network card, or any other device to enable the node to communicate with other nodes. In several example embodiments, any node represents a plurality of interconnected (whether by intranet or Internet) computer systems, including without limitation, personal computers, mainframes, PDAs, smartphones, and cell phones.

In several example embodiments, one or more of the components of the systems described above and/or illustrated in FIGS. 1-16, include at least the node 1000 and/or components thereof, and/or one or more nodes that are substantially similar to the node 1000 and/or components thereof. In several example embodiments, one or more of the above-described components of the node 1000, the system 10, and/or the example embodiments described above and/or illustrated in FIGS. 1-16, include respective pluralities of same components.

In several example embodiments, one or more of the applications, systems, and application programs described above and/or illustrated in FIGS. 1-16, include a computer program that includes a plurality of instructions, data, and/or any combination thereof; an application written in, for example, Arena, HyperText Markup Language (HTML), Cascading Style Sheets (CSS), JavaScript, Extensible Markup Language (XML), asynchronous JavaScript and XML (Ajax), and/or any combination thereof; a web-based application written in, for example, Java or Adobe Flex, which in several example embodiments pulls real-time information from one or more servers, automatically refreshing with latest information at a predetermined time increment; or any combination thereof.

In several example embodiments, a computer system typically includes at least hardware capable of executing machine readable instructions, as well as the software for executing acts (typically machine-readable instructions) that produce a desired result. In several example embodiments, a computer system may include hybrids of hardware and software, as well as computer sub-systems.

In several example embodiments, hardware generally includes at least processor-capable platforms, such as client-machines (also known as personal computers or servers), and hand-held processing devices (such as smart phones, tablet computers, personal digital assistants (PDAs), or personal computing devices (PCDs), for example). In several example embodiments, hardware may include any physical device that can store machine-readable instructions, such as memory or other data storage devices. In several example embodiments, other forms of hardware include hardware sub-systems, including transfer devices such as modems, modem cards, ports, and port cards, for example.

In several example embodiments, software includes any machine code stored in any memory medium, such as RAM or ROM, and machine code stored on other devices (such as floppy disks, flash memory, or a CD ROM, for example). In several example embodiments, software may include source or object code. In several example embodiments, software encompasses any set of instructions capable of being executed on a node such as, for example, on a client machine or server.

In several example embodiments, combinations of software and hardware could also be used for providing enhanced functionality and performance for certain embodiments of the present disclosure. In an example embodiment, software functions may be directly manufactured into a silicon chip. Accordingly, combinations of hardware and software are also included within the definition of a computer system and are thus envisioned by the present disclosure as possible equivalent structures and equivalent methods.

In several example embodiments, computer readable mediums include, for example, passive data storage, such as a random-access memory (RAM) as well as semi-permanent data storage such as a compact disk read only memory (CD-ROM). One or more example embodiments of the present disclosure may be embodied in the RAM of a computer to transform a standard computer into a new specific computing machine. In several example embodiments, data structures are defined organizations of data that may enable an embodiment of the present disclosure. In an example embodiment, a data structure may provide an organization of data, or an organization of executable code.

In several example embodiments, any networks and/or one or more portions thereof may be designed to work on any specific architecture. In an example embodiment, one or more portions of any networks may be executed on a single computer, local area networks, client-server networks, wide area networks, internets, hand-held and other portable and wireless devices, and networks.

In one aspect, the disclosure provides a rewards program system for educational institutions, the system including identification cards, wherein the identification cards are associated with user accounts, respectively; a plurality of card readers; wherein each card reader is associated with a merchant partner; and wherein each card reader is configured to read the identification cards; a plurality of remote user devices, wherein the remote user devices are associated with user accounts, respectively; and wherein each of the remote user devices includes a graphical user interface (“GUI”); a non-transitory computer readable medium having stored thereon a plurality of instructions, wherein the instructions are executed with at least one processor so that the following steps are executed: identifying a first user account and first user usage data when a card reader reads a first identification card; identifying a first branding theme associated with the first user account; converting the first user usage data to first reward points; assigning the first reward points to the first user account; identifying a first GUI that is associated with the first user account; displaying total reward points of the first user account on the first GUI using the first branding theme; wherein the total reward points of the first user account include the assigned first reward points; identifying a second user account and second user usage data when another card reader reads a second identification card; identifying a second branding theme associated with the second user account; converting the second user usage data to second reward points; assigning the second reward points to the second user account; identifying a second GUI that is associated with the second user account; and displaying total reward points of the second user account on the second GUI using the second branding theme; wherein the total reward points of the second user account include the assigned second reward points; wherein the first branding theme is associated with a first educational institution; and wherein the second branding theme is associated with a second educational institution that is different from the first educational institution. In one embodiment, the first branding theme includes any one or more of: a name of the first educational institution, an image of a mascot of the first educational institution, a name of the mascot of the first educational institution, and a color theme associated with the first educational institution; and wherein the second branding theme includes any one or more of: a name of the second educational institution, an image of a mascot of the second educational institution, a name of the mascot of the second educational institution, and a color theme associated with the second educational institution. In one embodiment, the instructions are executed with the at least one processor so that the following step is also executed: displaying a plurality of available rewards on the first GUI using the first branding theme; wherein the plurality of available rewards is based on the first user account and the first branding theme; and wherein at least a portion of the available rewards is associated with one of the merchant partners. In one embodiment, the instructions are executed with the at least one processor so that the following steps are also executed: receiving, using the first GUI, a user selection of a first reward of the plurality of available rewards; determining that the total reward points of the first user account exceeds a threshold level associated with the first reward; and creating a voucher for the first reward. In one embodiment, the first user account is associated with a prospective student of the first educational institution; and wherein the voucher is a tuition credit at the first educational institution. In one embodiment, determining that the total reward points of the first user account exceed a threshold level associated with the first reward includes referencing a reward fulfillment rule set; and wherein the fulfillment rule set identifies a set of reward fulfillment rules for each reward of the plurality of available rewards. In one embodiment, the first identification card is a credit card. In one embodiment, wherein the first GUI is displayed on a remote user device; wherein the first user account is associated with a prospective student of the first educational institution; and wherein the instructions are executed with the at least one processor so that the following steps are also executed: displaying a plurality of available rewards on the first GUI using the first branding theme; receiving, using the first GUI, a selection of a first reward, wherein the selection of the first reward is associated with an investment of funds for use at the first educational institution; receiving, using the first GUI, a request to open a new account, wherein the new account is associated with the investment of funds for use at the first educational institution; prepopulating an application to open the new account; and wherein the application is prepopulated using data associated with the first user account; wherein the prepopulation of the application reduces processing load of a processor of the remote user device. In one embodiment, the instructions are executed with the at least one processor so that the following step is also executed: transmitting the funds into the account at the first educational institution.

In one aspect, the disclosure provides a system including: a non-transitory computer readable medium having stored thereon a plurality of instructions, wherein the instructions are executed with at least one processor so that the following steps are executed: receiving, from a plurality of educational institutions, a rule set that includes reward calculation rules and reward fulfillment rules for each educational institution; receiving, from a plurality of merchants, user data and usage data for a plurality of users; wherein each user of the plurality of users is associated with an educational institution from the plurality of educational institutions; wherein each educational institution of the plurality of educational institutions is associated with a branding theme; and wherein the branding theme includes any one or more of: a name of the educational institution, a name of a mascot of the educational institution, and a color theme associated with the educational institution; calculating, for each user and based on the user data for the user, usage data for the user, and the rule set for the educational institution that is associated with the user, a reward point balance; and displaying, for each user and using the branding theme associated with the educational institution associated with the user, an available reward points balance on a graphical user interface that is associated with the user. In one embodiment, the instructions are executed with the at least one processor so that the following steps are also executed: receiving, from the plurality of merchants, authorization to offer a voucher redeemable with the merchant; identifying a user account that has requested a voucher; and automatically creating the voucher using the branding theme associated with the user account. In one embodiment, the instructions are executed with the at least one processor so that the following steps are also executed: identifying a plurality of available rewards that are capable of being customized using one of the branding themes; and receiving, from each of the educational institutions of the plurality of educational institutions, a selection of available rewards from the plurality of available rewards to be customized using the branding theme associated with the educational institution. In one embodiment, one of the available rewards that is capable of being customized using one of the branding themes is an award for tuition.

In yet another aspect, the disclosure provides a method that includes identifying, using one or more processors, a first user account and first user usage data when a card reader reads a first identification card; identifying, using the one or more processors, a first branding theme associated with the first user account; converting, using the one or more processors, the first user usage data to first reward points; assigning, using the one or more processors, the first reward points to the first user account; identifying, using the one or more processors, a first GUI that is associated with the first user account; displaying, using the one or more processors, total reward points of the first user account on the first GUI using the first branding theme; wherein the total reward points of the first user account include the assigned first reward points; identifying, using the one or more processors, a second user account and second user usage data when another card reader reads a second identification card; identifying, using the one or more processors, a second branding theme associated with the second user account; converting, using the one or more processors, the second user usage data to second reward points; assigning, using the one or more processors, the second reward points to the second user account; identifying, using the one or more processors, a second GUI that is associated with the second user account; and displaying, using the one or more processors, total reward points of the second user account on the second GUI using the second branding theme; wherein the total reward points of the second user account include the assigned second reward points; wherein the first branding theme is associated with a first educational institution; and wherein the second branding theme is associated with a second educational institution that is different from the first educational institution. In one embodiment, the first branding theme includes any one or more of: a name of the first educational institution, a name of a mascot of the first educational institution, and a color theme associated with the first educational institution; and wherein the second branding theme includes any one or more of: a name of the second educational institution, a name of a mascot of the second educational institution, and a color theme associated with the second educational institution. In one embodiment, the method also includes displaying, using the one or more processors, a plurality of available rewards on the first GUI using the first branding theme; wherein the plurality of available rewards is based on the first user account and the first branding theme. In one embodiment, the method also includes receiving, using the first GUI, a user selection of a first reward of the plurality of available rewards, determining, using the one or more processors, that the total reward points of the first user account exceed a threshold level associated with the first reward; and creating, using the one or more processors, a voucher for the first reward. In one embodiment, the first user account is associated with a prospective student of the first educational institution; and wherein the voucher is a tuition credit at the first educational institution. In one embodiment, determining that total reward points of the first user account exceed the threshold level associated with the first reward includes referencing a reward fulfillment rule set; and wherein the fulfillment rule set includes reward fulfillment rules for each reward of the plurality of available rewards. In one embodiment, the first user account is associated with a prospective student of the first educational institution; wherein the first reward is associated with an investment of funds to be used at the first educational institution; and wherein the method further includes: displaying a plurality of available rewards on the first GUI using the first branding theme; wherein the plurality of available rewards is based on the first user account and the first branding theme; and receiving, using the first GUI, a selection of a first reward, wherein the selection of the first reward is associated with an investment of funds for use at the first educational institution; and prepopulating an application to open an account with the first educational institution; wherein the application is prepopulated using data associated with the first user account.

In several example embodiments, a database may be any standard or proprietary database software. In several example embodiments, the database may have fields, records, data, and other database elements that may be associated through database specific software. In several example embodiments, data may be mapped. In several example embodiments, mapping is the process of associating one data entry with another data entry. In an example embodiment, the data contained in the location of a character file can be mapped to a field in a second table. In several example embodiments, the physical location of the database is not limiting, and the database may be distributed. In an example embodiment, the database may exist remotely from the server, and run on a separate platform. In an example embodiment, the database may be accessible across the Internet. In several example embodiments, more than one database may be implemented.

In several example embodiments, a plurality of instructions stored on a non-transitory computer readable medium may be executed by one or more processors to cause the one or more processors to carry out or implement in whole or in part the above-described operation of each of the above-described example embodiments of the system, the method, and/or any combination thereof. In several example embodiments, such a processor may include one or more of the microprocessor 1000a, any processor(s) that are part of the components of the system, and/or any combination thereof, and such a computer readable medium may be distributed among one or more components of the system. In several example embodiments, such a processor may execute the plurality of instructions in connection with a virtual computer system. In several example embodiments, such a plurality of instructions may communicate directly with the one or more processors, and/or may interact with one or more operating systems, middleware, firmware, other applications, and/or any combination thereof, to cause the one or more processors to execute the instructions.

In several example embodiments, the elements and teachings of the various illustrative example embodiments may be combined in whole or in part in some or all the illustrative example embodiments. In addition, one or more of the elements and teachings of the various illustrative example embodiments may be omitted, at least in part, and/or combined, at least in part, with one or more of the other elements and teachings of the various illustrative embodiments.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several example embodiments, while different steps, processes, and procedures are described as appearing as distinct acts, one or more of the steps, one or more of the processes, and/or one or more of the procedures may also be performed in different orders, simultaneously, and/or sequentially. In several example embodiments, the steps, processes and/or procedures may be merged into one or more steps, processes, and/or procedures.

In several example embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

The phrase “at least one of A and B” should be understood to mean “A, B, or both A and B.” The phrase “one or more of the following: A, B, and C” should be understood to mean “A, B, C, A and B, B and C, A and C, or all three of A, B, and C.” The phrase “one or more of A, B, and C” should be understood to mean “A, B, C, A and B, B and C, A and C, or all three of A, B, and C.”

Although several example embodiments have been described in detail above, the embodiments described are examples only and are not limiting, and those skilled in the art will readily appreciate that many other modifications, changes, and/or substitutions are possible in the example embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A rewards program system for educational institutions, the system comprising:
identification cards,
wherein the identification cards are associated with user accounts, respectively; and
wherein each identification card comprises:
a chip that stores data that identifies the user account associated with the identification card;
a magnetic stripe that stores data that identifies the user account associated with the identification card; or
both the chip and the magnetic stripe;
card readers,
wherein each card reader is associated with a merchant partner; and
wherein each card reader is configured to read:
the respective chips of the identification cards;
the respective magnetic stripes of the identification cards; or
both the respective chips of the identification cards and the respective magnetic stripes of the identification cards;
remote user devices,
wherein the remote user devices are associated with user accounts, respectively; and
wherein each of the remote user devices comprises a graphical user interface (“GUI”);
and
a non-transitory computer readable medium having stored thereon instructions, wherein the instructions are executed with at least one processor so that the following steps are executed:
identifying a first user account and first user usage data when a card reader reads a first identification card;
identifying a first branding theme associated with the first user account;
converting the first user usage data to first reward points;
assigning the first reward points to the first user account;
identifying a first GUI that is associated with the first user account;
displaying total reward points of the first user account on the first GUI using the first branding theme;
wherein the total reward points of the first user account include the assigned first reward points;
identifying a second user account and second user usage data when another card reader reads a second identification card;
identifying a second branding theme associated with the second user account;
converting the second user usage data to second reward points;
assigning the second reward points to the second user account;
identifying a second GUI that is associated with the second user account; and
displaying total reward points of the second user account on the second GUI using the second branding theme;
wherein the total reward points of the second user account include the assigned second reward points;
wherein the first branding theme is associated with a first educational institution; and
wherein the second branding theme is associated with a second educational institution that is different from the first educational institution.

2. The system of claim 1,
wherein the first branding theme comprises any one or more of: a name of the first educational institution, an image of a mascot of the first educational institution, a name of the mascot of the first educational institution, and a color theme associated with the first educational institution; and
wherein the second branding theme comprises any one or more of: a name of the second educational institution, an image of a mascot of the second educational institution, a name of the mascot of the second educational institution, and a color theme associated with the second educational institution.

3. The system of claim 1, wherein the instructions are executed with the at least one processor so that the following step is also executed:
displaying a plurality of available rewards on the first GUI using the first branding theme;
wherein at least a portion of the available rewards is associated with one of the merchant partners.

4. The system of claim 3, wherein the instructions are executed with the at least one processor so that the following steps are also executed:
receiving, using the first GUI, a user selection of a first reward of the plurality of available rewards;
determining that the total reward points of the first user account exceeds a threshold level associated with the first reward; and
creating a voucher for the first reward.

5. The system of claim 4,
wherein the first user account is associated with a prospective student of the first educational institution; and
wherein the voucher is a tuition credit at the first educational institution.

6. The system of claim 4,
wherein determining that the total reward points of the first user account exceeds a threshold level associated with the first reward comprises referencing a reward fulfillment rule set; and
wherein the fulfillment rule set identifies a set of reward fulfillment rules for each reward of the plurality of available rewards.

7. The system of claim 1, wherein the first identification card is a credit card.

8. The system of claim 1,
wherein the first GUI is displayed on a remote user device;
wherein the first user account is associated with a prospective student of the first educational institution;
wherein the instructions are executed with the at least one processor so that the following steps are also executed:
displaying a plurality of available rewards on the first GUI using the first branding theme;
receiving, using the first GUI, a selection of a first reward, wherein the selection of the first reward is associated with an investment of funds for use at the first educational institution;
receiving, using the first GUI, a request to open a new account, wherein the new account is associated with the investment of funds for use at the first educational institution; and
prepopulating an application to open the new account;
wherein the application is prepopulated using data associated with the first user account; and
wherein the prepopulation of the application reduces processing load of a processor of the remote user device.

9. The system of claim 8, wherein the instructions are executed with the at least one processor so that the following step is also executed: transmitting the funds into the new account.

10. A system comprising:
a non-transitory computer readable medium having stored thereon a plurality of instructions, wherein the instructions are executed with at least one processor so that the following steps are executed:
receiving, from a plurality of educational institutions, a rule set that comprises reward calculation rules and reward fulfillment rules for each educational institution;
receiving, from a plurality of merchants, user data and usage data for a plurality of users;
wherein each user of the plurality of users is associated with an educational institution from the plurality of educational institutions;
wherein each educational institution of the plurality of educational institutions is associated with a branding theme; and
wherein the branding theme comprises any one or more of: a name of the educational institution, a name of a mascot of the educational institution, and a color theme associated with the educational institution;
calculating, for each user and based on the user data for the user, usage data for the user, and the rule set for the educational institution that is associated with the user, a reward point balance; and
displaying, for each user and using the branding theme associated with the educational institution associated with the user, an available reward points balance on a graphical user interface that is associated with the user.

11. The system of claim 10, wherein the instructions are executed with the at least one processor so that the following steps are also executed:
receiving, from the plurality of merchants, authorization to offer a voucher that is redeemable with the merchant;
identifying a user account that has requested a voucher; and
automatically creating the voucher using the branding theme associated with the user account.

12. The system of claim 10, wherein the instructions are executed with the at least one processor so that the following steps are also executed:
identifying a plurality of available rewards that are capable of being offered using one of the branding themes; and
receiving, from each of the educational institutions of the plurality of educational institutions, a selection of available rewards from the plurality of available rewards.

13. The system of claim 12, wherein one of the available rewards is an award for tuition.

14. A method comprising:
identifying, using one or more processors, a first user account and first user usage data when a card reader reads a first identification card;
identifying, using the one or more processors, a first branding theme associated with the first user account;
converting, using the one or more processors, the first user usage data to first reward points;
assigning, using the one or more processors, the first reward points to the first user account;
identifying, using the one or more processors, a first GUI that is associated with the first user account;
displaying, using the one or more processors, total reward points of the first user account on the first GUI using the first branding theme;
wherein the total reward points of the first user account include the assigned first reward points;
identifying, using the one or more processors, a second user account and second user usage data when another card reader reads a second identification card;
identifying, using the one or more processors, a second branding theme associated with the second user account;
converting, using the one or more processors, the second user usage data to second reward points;
assigning, using the one or more processors, the second reward points to the second user account;
identifying, using the one or more processors, a second GUI that is associated with the second user account; and
displaying, using the one or more processors, total reward points of the second user account on the second GUI using the second branding theme;
wherein the total reward points of the second user account include the assigned second reward points;
wherein the first branding theme is associated with a first educational institution; and
wherein the second branding theme is associated with a second educational institution that is different from the first educational institution.

15. The method of claim 14,
wherein the first branding theme comprises any one or more of: a name of the first educational institution, a name of a mascot of the first educational institution, and a color theme associated with the first educational institution; and
wherein the second branding theme comprises any one or more of: a name of the second educational institution, a name of a mascot of the second educational institution, and a color theme associated with the second educational institution.

16. The method of claim 14, further comprising:
displaying, using the one or more processors, a plurality of available rewards on the first GUI using the first branding theme;
wherein the plurality of available rewards is based on the first user account.

17. The method of claim 16, further comprising:
receiving, using the first GUI, a user selection of a first reward of the plurality of available rewards,
determining, using the one or more processors, that the total reward points of the first user account exceeds a threshold level associated with the first reward; and
creating, using the one or more processors, a voucher for the first reward.

18. The method of claim 17,
wherein the first user account is associated with a prospective student of the first educational institution; and
wherein the voucher is a tuition credit at the first educational institution.

19. The method of claim 17,
wherein determining that total reward points of the first user account exceed the threshold level associated with the first reward comprises referencing a reward fulfillment rule set; and
wherein the fulfillment rule set includes reward fulfillment rules for each reward of the plurality of available rewards.

20. The method of claim 14,
wherein the first user account is associated with a prospective student of the first educational institution;
wherein the first reward is associated with an investment of funds to be used at the first educational institution; and
wherein the method further comprises:
displaying a plurality of available rewards on the first GUI using the first branding theme;
receiving, using the first GUI, a selection of a first reward, wherein the selection of the first reward is associated with an investment of funds for use at the first educational institution; and
prepopulating an application to open a new account;
wherein the application is prepopulated using data associated with the first user account.
